(19) United States
(12) Patent Application Publication
(10) Pub. No.: US 2014/0024486 A1
(43) Pub. Date: Jan. 23, 2014

(54) DRIVE ASSEMBLY FOR TIRE SERVICE MACHINES

(71) Applicants: Paolo SOTGIU, Modena (IT); Lillo GUCCIARDINO, Bomporto (IT)

(72) Inventors: Paolo SOTGIU, Modena (IT); Lillo GUCCIARDINO, Bomporto (IT)

(21) Appl. No.: 13/554,761

(22) Filed: Jul. 20, 2012

(51) Int. Cl. F16H 1/28

(52) U.S. Cl. 475/149

(57) ABSTRACT

The invention provides a drive assembly for tire service machines comprising a drive motor having a rotatable output drive shaft, and a wheel support. The inventive drive assembly further provides a gear unit having at least one gearbox, at least a gear unit input shaft and a gear unit output shaft. The wheel support is in direct torque transmitting connection with the gear unit output shaft, wherein the output drive shaft of the drive motor is in a direct torque transmitting connection with the gear unit input shaft of the gear unit.

The invention relates to an improved drive assembly for rotating and supporting a wheel to be serviced on a tire service machine. Furthermore, the invention relates to a tire changer for mounting and demounting a tire onto and from a rim, using an improved drive assembly. Additionally, the invention relates to a wheel balancer for balancing a wheel using an improved drive assembly.

A drive assembly for rotating and supporting a wheel in a tire mounting and demounting machine is known from EP patent application 1 724 125. A shaft being arranged vertically is directly coupled to an electro motor being arranged beneath the shaft. A rim to be serviced is placed on a wheel support driven by the shaft. When rotating, the shaft rotates a cone which clamps the rim of a wheel to be serviced against the wheel support. The whole driving force of the rotating movement for the drive assembly has to be applied by the motor which has to be powerful. Therefore, it is inevitable to have a big and powerful motor which is expensive and takes installation space. Furthermore, the arrangement of the known drive assembly provides another disadvantage. The mounting and demounting procedure that follows the clamping of a rim on the wheel support surface, is done by means of relatively high operation forces, which in general have to be accepted in a solid frame the drive assembly is accommodated.

A balancing machine for rotating bodies is known from EP patent application 1 367 374. A motor drives a shaft supporting a rotating body, in particular a wheel. The shaft is supported by tension members to measure the unbalance of the rotating body. The motor, which shall not produce noticeable vibrations in order to avoid a negative influence to the measuring results of the balancing machine, drives the rotating body. Therefore, normally the motor is chosen bigger than required to prevent the motor from producing noticeable vibrations. This provision of a motor being bigger than required also rises the costs for a balancing machine for rotating bodies.

Therefore, it is an object of the present invention to provide a drive assembly for tire service machines that requires a motor providing less torque and having smaller dimensions than that of tire service machines of the prior art.

In a first embodiment, the invention provides a drive assembly for tire service machines comprising a drive motor having a rotatable output drive shaft, and a wheel support. Furthermore, the inventive drive assembly provides a gear unit. The gear unit has at least a gear unit input shaft and a gear unit output shaft. The wheel support is in direct torque transmitting connection with the gear unit output shaft, wherein the output drive shaft of the drive motor is in a direct torque transmitting connection with the gear unit input shaft of the gear unit. Furthermore, the gear unit comprises at least one gearbox.

With this solution it is possible to use a drive motor that provides less torque and power, and has smaller dimensions than a drive motor for wheel service machines of the prior art. The drive motor is chosen from a group of drives consisting of e.g. an electric motor, preferably an asynchronous motor, a fluid driven motor or any possible combination thereof. The output drive shaft of the drive motor can be provided with a polygon profile, a pinion gear geometry or any other geometrical connection that enables a direct torque transmitting connection to the gear unit input shaft of the gear unit.

The direct torque transmitting connection of the output drive shaft of the drive motor and the gear unit input shaft can be provided by a rigid connection, for example a one piece shaft, or a detachable connection. The detachable connection can, for example, be provided by a flange connection between a gear unit input shaft flange and an the output drive shaft flange of the drive motor, connected by bolts, screws or any other possible way of connecting both shafts. Furthermore, the detachable connection can also be provided by a clutch, for example a friction clutch, a fluid driven clutch or the like. Additionally, the detachable connection of both shafts can be provided by a detachable joint, e.g. an Oldham joint. If the direct torque transmitting connection can be easily detached, this enables an easy way to exchange the drive motor and/or the gear unit. The gear unit comprises at least one gearbox with or without further reduction or transmission stages, e.. step-up gears, step-down gears as well as any other geometrical arrangement for transmission. Besides any possible further transmission means, connecting means or damping means may also be arranged between the gear unit input shaft and the at least one gearbox, between the at least one gearbox and the gear unit output shaft, or between two or more gearboxes. Furthermore, without transmission, connecting or damping means between the gear unit input shaft and the gearbox, a gearbox input shaft corresponds to the gear unit input shaft. Same is true for a gearbox output shaft. The gearbox output shaft corresponds to the gear unit output shaft in case no further transmission, connecting or damping means are arranged between the gearbox and the gear unit output shaft.

The drive assembly can be arranged in a vertical orientation along a common rotating axis, in a horizontal orientation or in any other orientation between the horizontal and vertical orientation depending on the configuration of the wheel service machine, the inventive drive assembly shall be used with.

Generally, a wheel to be serviced is connected in a torque transmitting connection to the wheel support which can be constituted e.g. by a plate, chuck jaws, brackets, a centering cone for example being screwable in a hollow shaft, a self centering and anti-slipping system as well as any other means adapted to support a wheel rotationally fixed and centered to a rotatable shaft.

The gear unit is adapted to transmit low- and high rotational speed as well as low and high torque. The transmission may be done by means of the at least one gearbox, with or without further transmission means as already explained above.

As already mentioned above, a toothed gear of the gearbox being part of the gear unit can be directly connected to the output drive shaft of the drive motor. In such an arrangement, the output drive shaft of the drive motor extends inside the gear unit to connect the gear unit input shaft to the output drive shaft of the drive motor for establishing a direct torque transmitting connection between the gear unit input shaft and the output drive shaft of the drive motor.

Furthermore, with a direct torque transmitting connection between the output drive shaft of the drive motor and the gear unit input shaft, no pulleys, belts or the like are needed for transmitting the rotating motion provided by the output drive shaft of the drive motor. This leads to the fact, that the maintenance costs can be hold relatively low, and furthermore the drive assembly is easier to manufacture and service.

In an aspect of the present invention, the gear unit input shaft can be coaxial to the output drive shaft of the drive motor. The coaxiality of the output drive shaft of the drive motor and the gear unit input shaft provides the advantage that no rotary unbalances can be generated in this direct torque transmitting connection, because the gear unit input shaft rotates around the common axis of rotation with the output drive shaft of the drive motor.

In a further aspect of the present invention, the gear unit output shaft can be coaxial to the output drive shaft of the drive motor. With the coaxiality of the gear unit output shaft and the output drive shaft of the drive motor, the wheel support rotates around the common axis of the output drive shaft of the drive motor and the gear unit output shaft. Therewith, also the wheel which can be placed on the wheel support, rotates around the common axis of the output drive shaft of the drive motor and the gear unit output shaft. This leads to small rotary unbalance forces acting on the drive assembly. Furthermore, because of the coaxiality of the gear unit output shaft and the output drive shaft of the drive motor, no offset between said two shaft axes is present. Therewith, the installation space for the inventive drive assembly is minimized.

The connection of the output drive shaft of the drive motor and the gear unit input shaft can be provided by a rigid connection, for example a one piece shaft, or a detachable connection. The detachable connection can, for example, be provided by a flange connection between a gear unit input shaft flange and the output drive shaft flange of the drive motor, connected by bolts, by means of screws or any other possible way of connecting both shafts. Furthermore, the detachable connection can also be provided by a clutch, for example a friction clutch, a fluid driven clutch or the like. Additionally, the detachable connection of shafts can be provided by a detachable joint, e.g. an Oldham joint.

Moreover, the drive motor can be an electric motor which is speed controlled by an inverter. With the deployment of an inverter that controls the speed of the electric motor, a movement in a direction against a main rotating direction of the electric motor can be prevented. The voltage supply of the electric motor is done by the inverter, which uses pulse width modulation. Furthermore, by means of an inverter, the electric motor can be controlled in a wide velocity range.

The current supplying the electric motor can be changed by the inverter with a high frequency such that by means of the inertia of the rotor, a holding torque keeps the rotor fixedly in position. Together with the rotor of the electric motor, also the gear unit, providing the gear unit output shaft, and the wheel support are held in position.

In a first variant of the present invention, the at least one gearbox, which is a part of the gear unit, can be a multi-stage device. In particular, the gearbox can have at least two stages, and at least two gearing shafts. The gear unit input shaft may coincide with the gear unit output shaft, wherein at least one of the gearing shafts may be a hollow shaft. Alternatively, the gear unit input shaft may be coaxial with the gear unit output shaft, or may be offset from the gear unit output shaft, which is the common way of use for multi-stage devices. In a further alternative, the gear unit input shaft and the gear unit output shaft may coincide with the gearing shafts of the at least two gearing stages of the multi-stage device.

In a second variant of the present invention, the at least one gearbox being part of the gear unit, can be a single stage device, preferably a planetary gear. In principle, a single stage gearbox can also be formed by a pair of toothed gears, which is a simple and non-cost-effective way to transmit torque and rotating speed. However, the single stage gearbox in form of a pair of toothed gears shows the disadvantage of the gear unit input shaft and the gear unit output shaft having an offset from each other. This leads to vibrations and may lead to rotating forces which have to be absorbed by a casing of the gearbox and the gear unit, respectively.

While the transmission range of a pair of toothed gears is highly limited, a transmission by a planetary gear, which is a single stage transmission, too, offers a high range of possible transmission ratios, in particular a reduction from at least 1:150, more preferably 1:170 or even 1:200. This high transmission ratio is possible because of the fact that more toothed gears are in engagement permanently.

The use of a planetary gear offers the advantage, that little vibrations are produced. Furthermore, the use of a planetary gear provides the advantage, that the gear unit input shaft may be coaxial to the gear unit output shaft, which leads to little vibrations produced by the planetary gear. The dimension of the planetary gear is smaller than the one of a common single stage transmission with a pair of toothed gears or a multi stage transmission with or without an offset between the gear unit input shaft and the gear unit output shaft. In particular, the diameter as well as the height of the planetary gear are smaller than the dimensions of the wheel to be serviced placed onto the wheel support. This improves the operability of the drive assembly for the working person placing a wheel onto the wheel support.

Preferably at least one of the three gearbox shafts of the planetary gear can be provided as hollow shaft.

In another aspect of the present invention, the drive assembly can be adapted to provide structural support. The drive assembly can be supported by a support unit or frame, respectively, which can be a rigid and rotationally stationary casing. The support unit is adapted to support not only the weight force of the wheel, but also the vibrations produced by the drive assembly, the rotational inertia force of the rotated wheel, and the forces which are exerted onto the wheel by a possible tool—for example a bead breaking tool.

The casing of the drive motor and the casing of the gear unit together with the gearbox can be a part of the support unit, too. Therefore, the rotating wheel support or the gear unit output shaft have to be rotationally decoupled from the gear unit casing and the drive motor casing, for example by a bearing as mentioned above. The gear unit casing is adapted to completely or partially cover or replace the gearbox casing.

Furthermore, the gear unit, together with the at least one gearbox, is able to provide structural force to the drive assembly. In particular, the planetary gearbox is adapted to cope with forces along the gear unit input shaft and the gear unit output shaft. In case a gear unit with a multi-stage gearbox with toothed gears is provided, also this gear unit is at least partially able to provide structural support for example by means of herringbone gears.

The drive assembly, being adapted to provide structural support, can directly be put on the floor, for example on a basement the wheel service machine is installed onto. Therewith, the flux of forces can therefore be directed in the basement the wheel service machine is installed onto. This leads to a possible omission of a structural cross beam which has been needed to close the flux of forces and to direct the flux of forces from any used tool, penetrating a wheel to be serviced, back to the frame.

Preferably, a bearing separating the rotating wheel support from the rotationally fixed gear unit housing, the gearbox housing or support unit, respectively, is provided. This bearing can for example further be supported by the gear unit housing, the gearbox housing or the support unit.

In a further aspect of the present invention, the gear unit output shaft and the wheel support can be made from one piece. With the one piece configuration for the gear unit output shaft and the wheel support, no additional parts have to be rotated by the drive motor. The wheel support and the gear unit output shaft can rotate along a common axis of rotation. Thereby, no additional unbalance forces or rotational forces and torques have to be absorbed by the drive assembly.

In an additional aspect, the gear unit can be directly flanged onto the drive motor. This can be realized by a connection of bolts, countered screws or any other possible way of connection. Preferably, this connection of gear unit and drive motor is detachable in order to be easily detached in case of service workings or the like. The installation space the drive assembly takes can be reduced.

It is further possible that the gear unit can be flanged on the side of the motor providing the output drive shaft of the drive motor.

In another embodiment of the present invention, a tire changer for mounting and demounting a tire onto or from a rim comprises a machine frame, at least one tool for performing a mounting and/or demounting operation, and a drive assembly according to claims 1 to 9.

In a first variant, the tire changer can be of the “Swing” type, which means a cylinder providing at least a debeading tool is provided externally to the machine frame of the tire changer.

In a second variant, the tire changer can be of the “Tilting tower” type, which means a cylinder providing at least a debeading tool and another cylinder tilting the tower are provided externally to the machine frame of the tire changer.

In another variant, the tire changer can be of any possible geometrical arrangement affording a wheel support rotated by a drive motor.

Furthermore, the drive assembly can be placed externally with respect to the machine frame of the tire changer.

Actuating pedals, displaced on a pedals pad, can be placed external to the tire changer machine frame, too. With an arrangement like that, the drive assembly which is not directly integrated in the machine frame of the tire changer, is easily accessible for a person performing any service task.

The drive assembly can be attached such that it is hanging on the tire changer machine frame. Therewith, the drive assembly does not touch the floor, in particular the basement onto which the tire changer is installed.

In a variant of the present embodiment, the drive assembly is placed externally with respect to the machine frame of the tire changer, and furthermore touches the floor, in particular the basement onto which the tire changer is installed.

In another preferred embodiment, a wheel balancer for balancing a wheel or a rim of a wheel comprises a machine frame, at least one measuring unit for measuring a possible unbalance of the wheel or rim, and a drive assembly according to claims 1 to 9.

In view of all inventions described therein, the gear unit together with the at least one gearbox can be equipped with a shiftable geometry together with at least one shifting actuator. Therefore, the gear unit may provide a shift collar, together with a shifting fork or the like which enables the gear unit to shift gears. Therewith, it is further possible to reverse the rotating movement to turn the wheel support in a reverse direction by means of a reverse gear. This may be preferable in case of failure or emergency to prevent a working person from being injured.

Furthermore, an arrangement like this enables the drive assembly to consider deeply the different demands on rotating force and actuating force exerted by any tools penetrating the wheels. Especially in case wheels with heavy weight and reinforced sidewalls, for example self supporting runflat tires, are to be serviced in tire service machines, a shiftable gear unit is highly appreciated because proper servicing of this wheels requires high torque and force applied by the drive motor. The relationship between rotating speed and applicable torque onto the wheel can then be controlled.

Other advantages and two embodiments of the present invention shall now be described with reference to the attached drawings. The terms “top”, “bottom”, “up”, “low”, “left” and “right” used when describing the embodiment, relate to the drawings orientated in such a way that the reference numerals and name of the figures can be read normally.

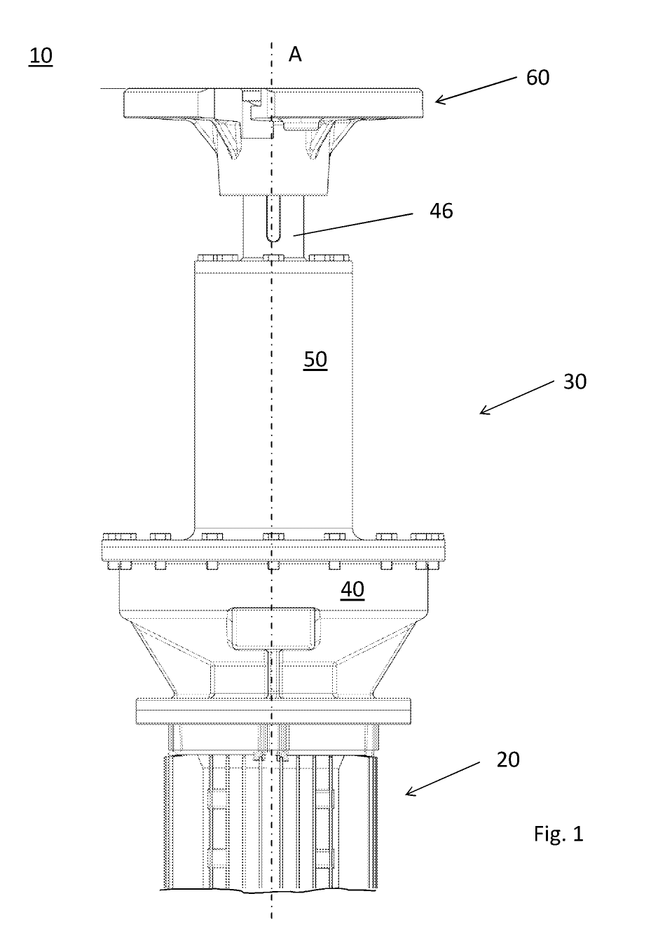

FIG. 1 shows a front view of the inventive drive assembly according to a first embodiment of the present invention;

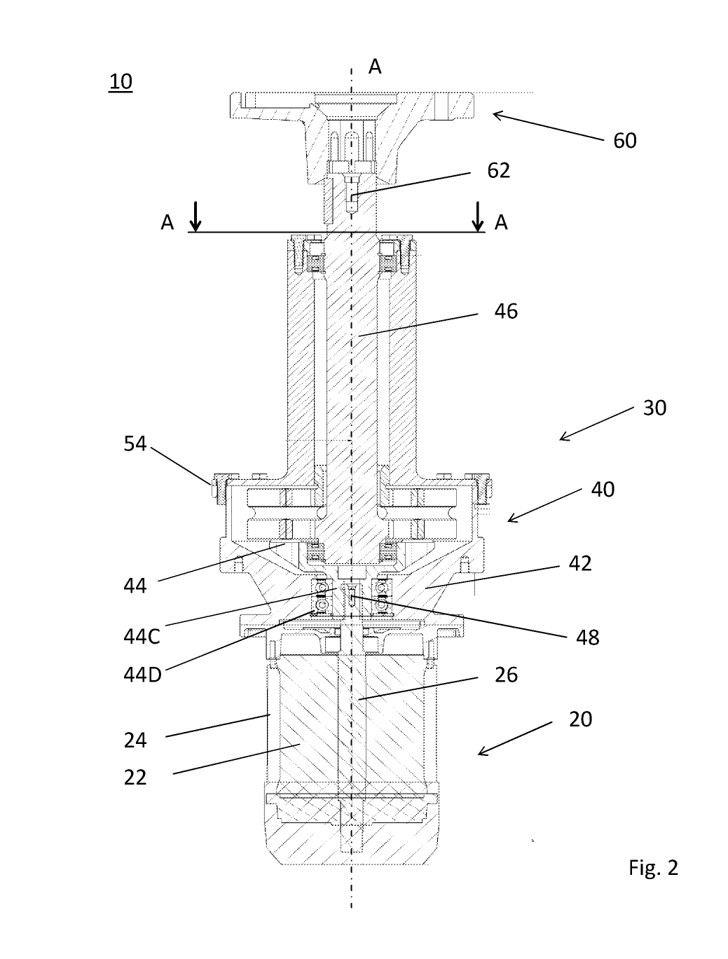

FIG. 2 shows a cross sectional view of the inventive drive assembly of FIG. 1;

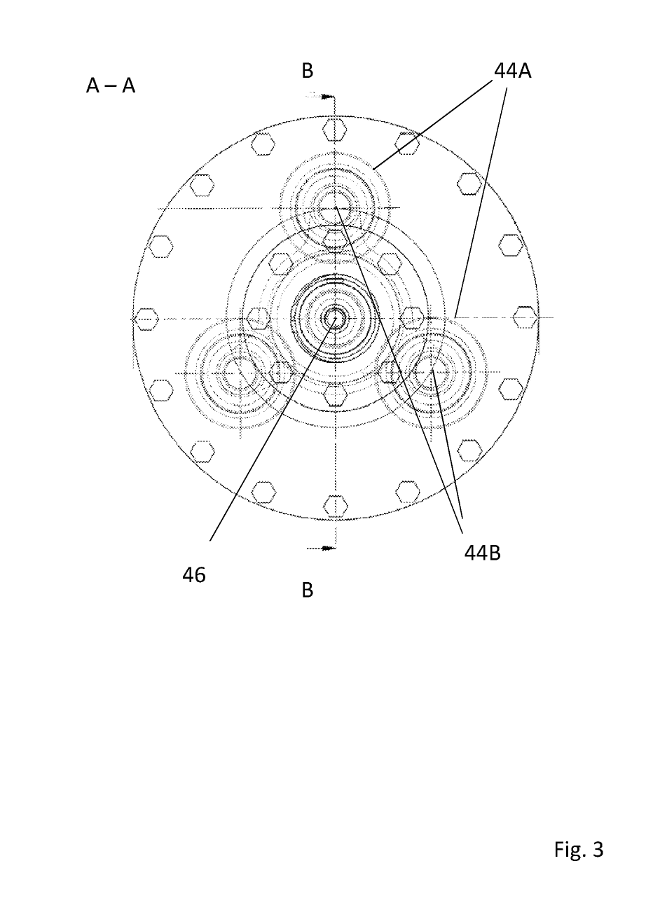

FIG. 3 shows a cross sectional view along the line A-A of FIG. 2;

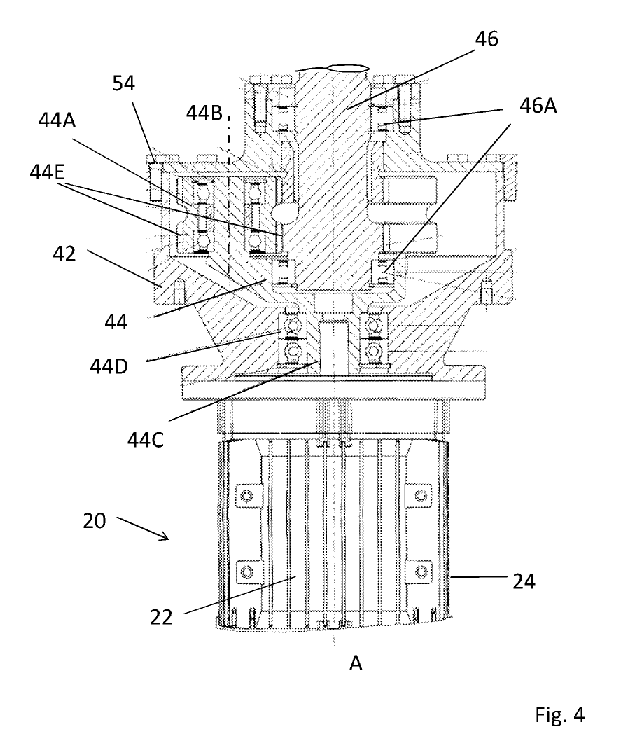

FIG. 4 shows a more detailed cross-sectional cut-away view along the line B-B of FIG. 3; and

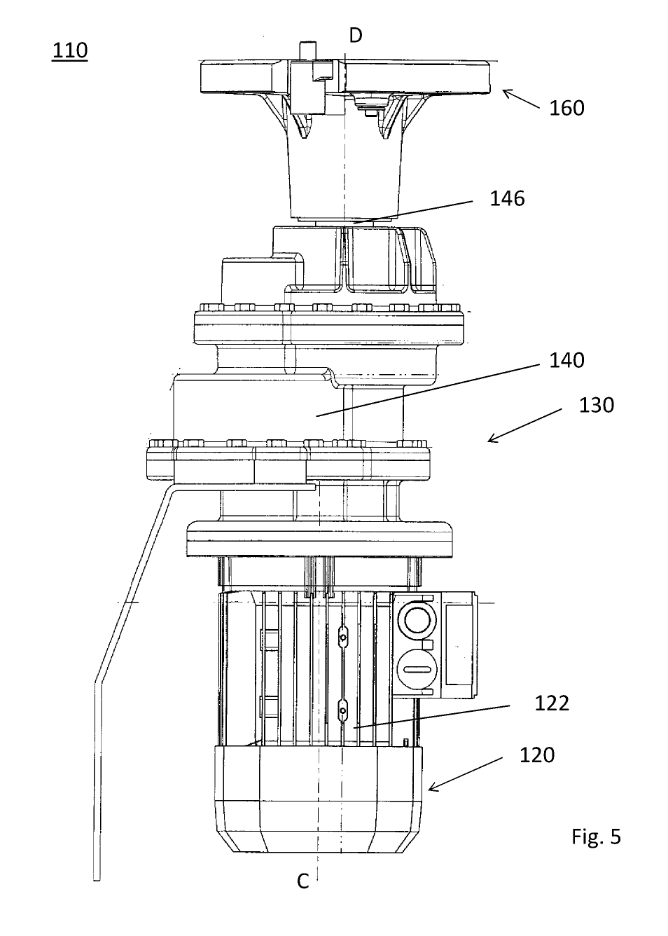

FIG. 5 shows a front view of the inventive drive assembly according to a second embodiment of the present invention;

In a first embodiment shown in FIG. 1, an inventive drive assembly 10 represents a component of a wheel service machine (not shown). The drive assembly 10 of FIG. 1 comprises as main components a drive unit 20, a gear unit 30 having a gearbox 40, a guide unit 50 and a wheel support unit 60, wherein the components of drive assembly 10 are arranged along a common axis of rotation A in vertical orientation. Gear unit 30 is directly flanged onto drive unit 20, both are arranged along common axis of rotation A. Wheel support unit 60, which is arranged adjacent to gear unit 30 in a direction opposite to drive unit 20, is adapted to support a wheel to be serviced (not shown) onto the wheel service machine inventive drive assembly 10 is used with.

Drive unit 20 comprises a drive motor 22 as shown in FIG. 2, having a drive motor casing 24 and a rotatable output drive shaft 26. In the present embodiment, drive motor 22 with its output drive shaft 26, together with gear unit 30 and wheel support unit 60 are arranged in a vertical direction as already mentioned above, however every orientation between the vertical and the horizontal orientation is possible.

Drive motor 22 is an electric motor, which is controlled by an inverter (not shown). Output drive shaft 26 of drive motor 22 is in direct torque transmitting connection to a gear unit input shaft (planet carrier shaft 44C) of gear unit 30, as explained in the following. Gear unit 30 is arranged directly above drive unit 20 in vertical direction, along common axis of rotation A.

Gear unit 30 comprises gearbox 40 and guide unit 50, wherein gearbox 40 is adjacent to drive motor 22. Gearbox 40 is a single stage device, in particular a planetary gearbox as shown in FIGS. 2, 3 and 4, comprising three gearing elements, namely an annulus 42, a planet carrier 44 carrying three planet gears 44A each being rotatable around rotating axes 44B, and a sun gear 46. Annulus 42, an outer ring with inwardly facing teeth (not shown), is rotationally fixed and rigidly connected to drive motor casing 24. Furthermore, annulus 42 represents a gearbox housing, and therewith a part of a gear unit housing. The outwardly facing teeth 44E of planet gears 44A mesh with inwardly facing teeth of annulus 42.

Rotating axes 44B of three planet gears 44A, all of same size, are joined in planet carrier 44. Planet carrier 44 combines rotating axes 44B of planet gears 44A to a single planet carrier shaft 44C. Planet carrier shaft 44C is axially held by a bearing 44D of planet carrier 44. Furthermore, planet carrier shaft 44C represents the gear unit input shaft. Output drive shaft 26 of drive motor 22 is fixedly connected by a connecting bolt 48 to gearbox input shaft being represented by planet carrier shaft 44C. Because of the direct torque transmitting connection between gear unit input shaft 44C and output drive shaft 26 of drive motor 22, gear unit input shaft 44C directly follows a rotating movement of output drive shaft 26 of drive motor 22.

Gear unit output shaft is represented by the third gearing element, sun gear 46. Sun gear 46 is coaxial to planet carrier 44 as well as output drive shaft 26 of drive motor 22. Therewith, sun gear 46 is coaxial to output drive shaft 26 along common axis of rotation A.

Guide unit 50 (see FIG. 2) which is a component of gear unit 30, comprises an elongated casing 52 for gear unit output shaft 46. Furthermore, elongated casing 52 is fixedly connected by means of screws 54 to gearbox housing represented by annulus 42. Elongated casing 52 which rotatably supports gear unit output shaft 46 via a bearing 56, is elongated along common axis of rotation A of output drive shaft 26 of drive motor 22, gear unit input shaft 44 and gear unit output shaft 46. Generally, guide unit 50 is solely used for elongating the drive assembly 10 along the common axis of rotation A. Therewith, a comfortable working position of wheel support unit 60 for a working person to lift a wheel to be serviced onto can be provided, also in case the drive assembly 10 is put on the floor or on the basement the tire service machine is provided onto.

Gear unit output shaft 46 protrudes from elongated casing 52 along common axis of rotation A. Wheel support unit 60 is in torque transmitting connection with gear unit output shaft 46 by means of a connecting element 62 which is represented by a bolt, located pivotally on wheel support unit 60 and screwed into sun gear 46 along common axis of rotation A. Connecting element 62 ensures a fixed connection such that wheel support unit 60 is forced to directly follow a rotating movement of gear unit output shaft 46 guided in elongated casing 52.

In a second embodiment shown in FIG. 5, a drive assembly 110 represents a component of a wheel service machine (not shown), too. The drive assembly 110 as shown in FIG. 5 comprises as main components drive unit 120 and wheel support unit 160 similar to the first embodiment shown in FIGS. 1 to 4.

Furthermore, a multi stage gear unit 130 is constituted by a multi-stage gearbox 140, in particular a three-stage gearbox. Multi-stage gear unit 130 is directly flanged onto drive unit 120, and comprises a multi-stage gear unit input shaft (not shown) being coaxial to output drive shaft (not shown) of drive motor 122 along a rotary axis C. Besides a multi-stage gear unit input shaft, multi-stage gear unit comprises further a first gear shaft, a second gear shaft (both are not shown, too) and a multi-stage gear unit output shaft 146. The multi-stage gear unit output shaft 146 is coaxial to wheel support 160 along a wheel rotation axis D. Therewith, the drive torque applied by drive motor 122 on multi-stage gear unit input shaft is transmitted by three gear stages—from the multi-stage gear unit input shaft onto the first gear shaft, from the first gear shaft onto the second gear shaft, and finally from the second gear shaft onto the multi-stage gear unit output shaft.

Furthermore, wheel support unit 160, which is arranged adjacent to multi-stage gear unit 130 in a direction opposite to the drive unit 120, is adapted to support a wheel to be serviced onto the wheel service machine the inventive drive 110 assembly according to the second embodiment is used with.

Generally, multi-stage gear unit output shaft 146 can be coaxial to multi-stage gear unit input shaft.

In the second embodiment as shown in FIG. 5, multi-stage gear unit input shaft, which is coaxial to output drive shaft of drive motor 122, is offset from multi-stage gear unit output shaft 146. Therewith, wheel rotation axis D of wheel support unit 160, does not coincide with rotary axis C of output drive shaft of drive motor 122 or multi-stage gear unit input shaft, respectively.

The drive assembly 10, 110 of the present invention can be deployed with tire service machines, preferably with tire changers or wheel balancers.

REFERENCE LIST:

10, 110 drive assembly

A common axis of rotation

20, 120 drive unit

22, 122 drive motor

24 drive motor casing

26 output drive shaft

30 gear unit

40 planetary gearbox

42 annulus (gearbox housing)

44 planet carrier

44A planet gear

44B rotating axes of planet gears

44C planet carrier shaft (gear unit input shaft)

44D bearing of planet carrier

44E teeth

46 sun gear (gear unit output shaft)

46A bearing of sun gear

48 connecting bolt

50 guide unit

52 elongated casing

54 screws

56 bearing

60, 160 wheel support

62 connecting element

130 multi-stage gear unit

140 multi-stage gearbox

146 multi-stage gear unit output shaft

C rotary axis

D wheel rotation axis

1. A drive assembly for tire service machines, comprising:
a drive motor having a rotatable output drive shaft, and a wheel support,
characterized in that
a gear unit is provided, having at least one gearbox, a gear unit input shaft and a gear unit output shaft, and
the wheel support is in direct torque transmitting connection with the gear unit output shaft, and
wherein the output drive shaft of the drive motor is in a direct torque transmitting connection with the gear unit input shaft of the gear unit.

2. The drive assembly as claimed in claim 1,
characterized in that the gear unit input shaft is coaxial to the output drive shaft of the drive motor.

3. The drive assembly as claimed in claim 1,
characterized in that the gear unit output shaft is coaxial to the output drive shaft of the drive motor.

4. The drive assembly as claimed in claim 2,
characterized in that the gear unit output shaft is coaxial to the output drive shaft of the drive motor.

5. The drive assembly as claimed in claim 1,
characterized in that the drive motor is an electric motor, and wherein the electric motor is speed controlled by an inverter.

6. The drive assembly as claimed in claim 1,
characterized in that the gearbox is a multi-stage device.

7. The drive assembly as claimed in claim 1,
characterized in that the gearbox is a single-stage device, preferably a planetary gear.

8. The drive assembly as claimed in claim 1,
characterized in that the drive assembly is adapted to provide structural support.

9. The drive assembly as claimed in claim 1,
characterized in that the gear unit output shaft and the wheel support are made from one piece.

10. The drive assembly as claimed in claim 1,
characterized in that the gearbox is directly flanged onto the drive motor.

11. A tire changer for mounting and demounting a tire onto/from a rim, comprising:
a machine frame,
at least one tool for performing a mounting and/or demounting operation, and a drive assembly comprising
a drive motor having a rotatable output drive shaft; and
a wheel support,
characterized in that
a gear unit is provided, having at least one gearbox, a gear unit input shaft and a gear unit output shaft, and
the wheel support is in direct torque transmitting connection with the gear unit output shaft, and
wherein the output drive shaft of the drive motor is in a direct torque transmitting connection with the gear unit input shaft of the gear unit.

12. The tire changer as claimed in claim 11,
characterized in that the drive assembly is placed externally with respect to the machine frame of the tire changer.

13. The tire changer as claimed in claim 11,
characterized in that the gearbox is a multi-stage device.

14. The tire changer as claimed in claim 12,
characterized in that the gearbox is a multi-stage device.

15. The tire changer as claimed in claim 11,
characterized in that the gearbox is a single-stage device, in particular a planetary gear.

16. The tire changer as claimed in claim 12,
characterized in that the gearbox is a single-stage device, in particular a planetary gear.

17. The tire changer as claimed claim 11,
characterized in that the drive assembly is adapted to provide structural support.

18. A wheel balancer for balancing a wheel or a rim of a wheel, comprising:
a machine frame,
at least one measuring unit for measuring a possible unbalance of the wheel or rim, and
a drive assembly comprising
a drive motor having a rotatable output drive shaft; and
a wheel support,
characterized in that
a gear unit is provided, having at least one gearbox, a gear unit input shaft and a gear unit output shaft, wherein
the wheel support is in direct torque transmitting connection with the gear unit output shaft, and
wherein the output drive shaft of the drive motor is in a direct torque transmitting connection with the gear unit input shaft of the gear unit.
